(19) United States
(12) Patent Application Publication
(10) Pub. No.: US 2026/0098608 A1
(43) Pub. Date: Apr. 9, 2026

(54) PRESSURE VESSEL

(71) Applicant: TOYOTA JIDOSHA KABUSHIKI KAISHA, Toyota-shi (JP)

(72) Inventors: Osamu SAWAI, Okazaki-shi (JP); Yuki Kai, Nagoya-shi (JP); Youjirou Iriyama, Toyota-shi (JP); Asei Sato, Ichinomiya-shi (JP)

(73) Assignee: TOYOTA JIDOSHA KABUSHIKI KAISHA, Toyota-shi (JP)

(21) Appl. No.: 19/334,445

(22) Filed: Sep. 19, 2025

(30) Foreign Application Priority Data
Oct. 8, 2024 (JP) 2024-176693

(51) Int. Cl. F17C 1/06

(52) U.S. Cl. CPC F17C 1/06; F17C 2201/0147; F17C 2203/011; F17C 2203/0673; F17C 2221/012

(57) ABSTRACT

A pressure vessel that is able to store fluid includes a plurality of main body portions provided with a space inside, and one or more connection portions that communicate the main body portions to each other. The main body portion and the connection portion are alternately connected in series, and the connection portions are bent. A cross section perpendicular to a longitudinal direction of the main body portion has an outer shape including a linear portion and an arc portion. Each of the main body portions is disposed such that an outer peripheral surface located on the linear portion is in contact with an outer peripheral surface located on the linear portion of an adjacent main body portion.

### CROSS-REFERENCE TO RELATED APPLICATION

This application claims priority to Japanese Patent Application No. 2024-176693 filed on Oct. 8, 2024. The disclosure of the above-identified application, including the specification, drawings, and claims, is incorporated by reference herein in its entirety.

### BACKGROUND

### 1. Technical Field

The technique disclosed in the present specification relates to a pressure vessel.

### 2. Description of Related Art

Japanese Unexamined Patent Application Publication (Translation of PCT Application) No. 2018-519480 (JP 2018-519480 A) discloses a pressure vessel for storing fluid. The pressure vessel of JP 2018-519480 A includes alternating cylindrical tubes as liner cavities and flexible connectors, and is able to be folded inside a housing by bending a portion of flexible connectors.

### SUMMARY

Conventionally, since pressure vessels have been cylindrical in shape, it is difficult to say that the volume required to store fluid is efficiently secured.

The present specification discloses a pressure vessel that is able to store fluid. A pressure vessel includes a plurality of main body portions provided with a space inside, and one or more connection portions that communicate the main body portions to each other. The main body portion and the connection portion are alternately connected in series, and the connection portions are bent. A cross section perpendicular to a longitudinal direction of the main body portion has an outer shape including a linear portion and an arc portion.

According to the configuration, the cross section of the main body portion of the pressure vessel that is perpendicular to the longitudinal direction has the outer shape including the linear portion and the arc portion. Therefore, compared to the conventional case in which the cross section is circular, a larger volume is able to be secured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a pressure vessel;

FIG. 2 is a sectional view taken along line II-II of FIG. 1; and

FIG. 3 is a sectional view, taken from the same point of view as FIG. 2, of the pressure vessel after a reinforcing member has been wound around the pressure vessel.

### DETAILED DESCRIPTION OF EMBODIMENTS

The present embodiment will be described with reference to the drawings. Each figure is merely an example, and the present embodiment is not limited to the contents shown in the figures. Further, since each figure is merely an example, some parts may be omitted.

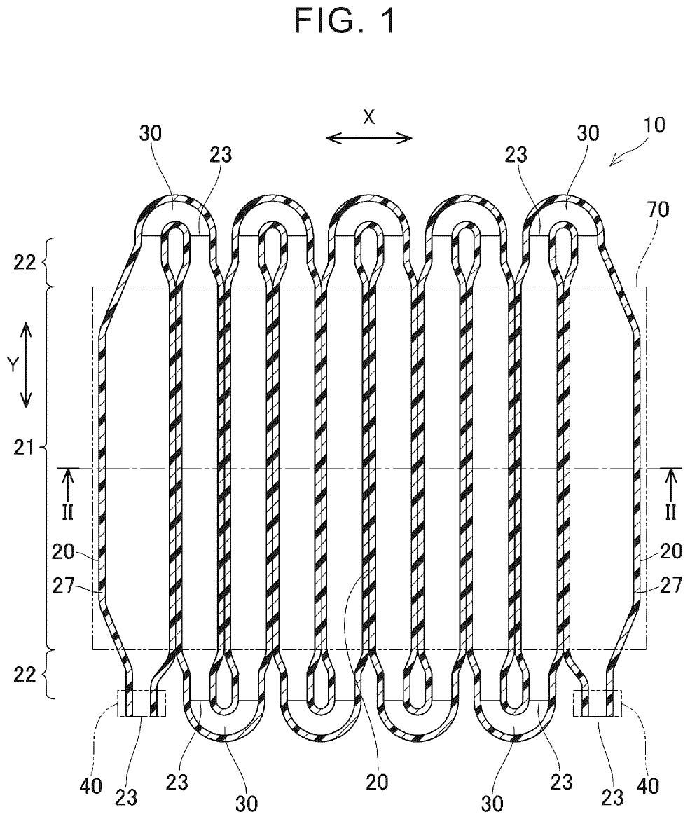

FIG. 1 is a simplified sectional view of a pressure vessel 10 according to the present embodiment. The pressure vessel 10 is able to store fluid. The fluid is, for example, a fuel gas such as hydrogen. In each figure, X and Y directions are appropriately indicated for ease of explanation. The X direction and the Y direction are orthogonal to each other. The pressure vessel 10 includes a plurality of main body portions 20 provided with a space inside, and one or more connection portions 30 that communicate the main body portions 20 to each other. Since the connection portion 30 communicates with the main body portions 20, a space is naturally provided inside.

According to FIG. 1, the main body portion 20 is elongated in the Y direction, and both ends in the Y direction are provided with an opening 23. According to FIG. 1, the Y direction corresponds to the longitudinal direction of the main body portion 20. The main body portion 20 includes a body portion 21 provided with a substantially uniformly shaped cross section perpendicular to the longitudinal direction, and tapered portions 22 that are both ends of the body portion 21 in the longitudinal direction. The tapered portion 22 narrows the cross-sectional area perpendicular to the longitudinal direction from the body portion 21 toward the opening 23 gradually or in a stepwise manner. Hereinafter, a cross section of the main body portion 20 perpendicular to the longitudinal direction will be referred to as a “first cross section”.

According to FIG. 1, the main body portions 20 are arranged side by side along the X direction (one direction). Further, the main body portions 20 are arranged at substantially the same position in the Y direction. When the pressure vessel 10 is viewed as a whole, the main body portions 20 and the connection portions 30 are alternately connected in series. The connection portion 30 is bent between the opening 23 of one main body portion 20 and the opening 23 of another main body portion 20. As shown in FIG. 1, the connection portion 30 is curved 180 degrees into a substantially U-shape, thereby communicating the main body portions 20 adjacent to each other in the X direction. In such a pressure vessel 10, the main body portions 20, from the main body portion 20 located at one end in the X direction to the main body portion 20 located at the other end, are continuously communicated.

Since the connection portion 30 is a tube that connects the opening 23 of one main body portion 20 to the opening 23 of another main body portion 20, its cross section perpendicular to the flow path direction is basically narrower than the first cross section of the body portion 21. However, in the present embodiment, it is not essential that the cross section of the connection portion 30 is narrower than the first cross section of the body portion 21. In other words, the main body portion 20 need not include the tapered portion 22, and each of both ends of the body portion 21 may be the opening 23. In this case, the body portion 21 and the connection portion 30 are directly connected to each other.

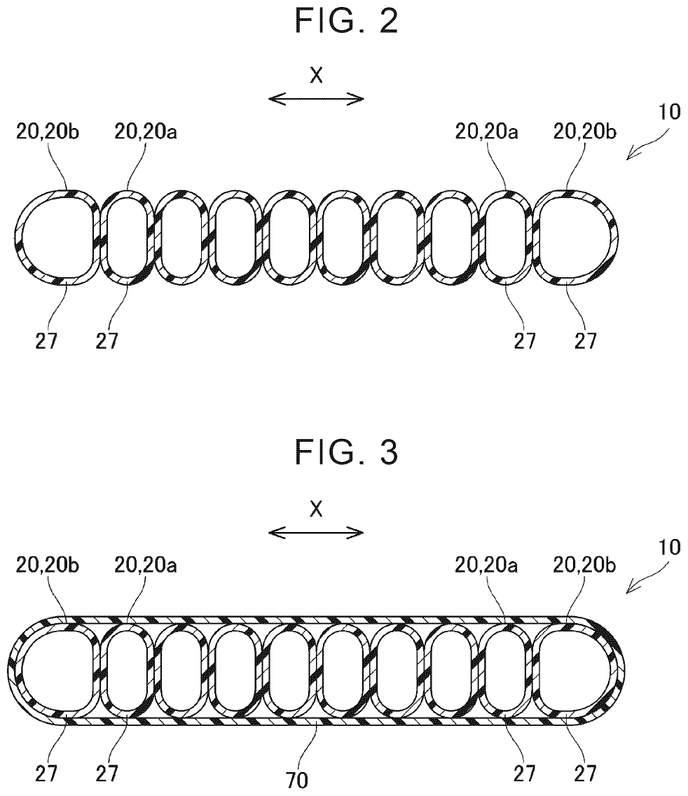

FIG. 2 is a sectional view taken along line II-II of FIG. 1. FIG. 2 shows the shape of the first cross sections of the main body portions 20. The first cross section has an outer shape including linear portions and arc portions. Therefore, according to the present embodiment, a larger volume for storing fluid is able to be secured, compared to a conventional configuration in which the cross section perpendicular to the longitudinal direction of the pressure vessel is circular.

As shown in FIG. 2, the first cross section of the main body portion 20 located at both ends in the arrangement of the main body portions 20 in the X direction (hereinafter, end main body portion 20b) has a different shape from the first cross section of the main body portion 20 located in the middle in the arrangement (hereinafter, intermediate main body portion 20a). The first cross section of the intermediate main body portion 20a has an oval shape with two linear portions and two arc portions. On the other hand, the first cross section of the end main body portion 20b includes a single linear portion and a single arc portion, and has an outer shape different from the oval shape.

Each of the main body portions 20 is disposed such that the outer peripheral surface located on the linear portion is in contact with the outer peripheral surface located on the linear portion of the adjacent main body portion 20. In other words, among the main body portions 20, the linear portions of the main body portions 20 adjacent to each other in the X direction are in contact with each other. By bringing the linear portions into contact in this manner, each main body portion 20 can appropriately suppress the expansion of the body portion 21 due to the expansion of the fluid.

As shown in FIG. 2, the first cross section of the end main body portion 20b may be generally semicircular or D-shaped. In other words, the first cross section of the end main body portion 20b has an arc shape on the side that is not adjacent to the adjacent main body portion 20 in the X direction. This allows the end main body portion 20b to appropriately maintain strength against fluid pressure. The shape and extent of the tapered portion 22 in the main body portion 20 may differ between the intermediate main body portion 20a and the end main body portion 20b.

An example of a method of manufacturing the pressure vessel 10 will be briefly described. Hereinafter, the pressure vessel 10 in a state before the connection portions 30 are bent will be referred to as the pressure vessel 10 before being bent. First, a liner is prepared as a hollow body that will be the base material of the pressure vessel 10 before bending. For example, the liner is made of a resin such as nylon. The liner is a hollow body in which main body shaped portions each having a shape corresponding to the main body portion 20 and connection shaped portions each having a shape corresponding to the connection portion 30 before bending are integrally molded to be alternately and linearly connected.

A wire is wound, for example in a mesh or spiral pattern, on the outer surface of such a liner by a winding machine. The winding machine is also called a braiding machine, braider, etc. The wire wound around the liner is made of carbon fiber reinforced plastics (CFRP) in which carbon fiber is impregnated with resin. By winding the wire by the winding machine, a fiber layer 27 made of CFRP is provided such that the fiber layer 27 covers the outer surface of the liner.

The liner and the winding machine move relative to each other along the longitudinal direction of the liner. For example, the winding machine is fixed in position while the liner moves along the longitudinal direction. As the wire moves, the winding machine winds the wire. This allows the pressure vessel 10 before bending to be manufactured efficiently. By using the integrally molded liner as a base material and performing the winding as described above to manufacture the entire pressure vessel 10 before bending, the number of parts and labor required can be reduced compared to the conventional method of manufacturing pressure vessels by joining together a plurality of parts of different thicknesses and shapes. Therefore, the pressure vessel 10 can be manufactured at low cost.

The manufactured pressure vessel 10 before bending is then bent at the connection portions 30 to make a substantially U-shape. Therefore, the pressure vessel 10 having the shape shown in FIG. 1 is manufactured. When the connection portions 30 are bent, the linear portions, i.e., the planar side surfaces of the main body portions 20 adjacent to each other in the X direction are pressed against each other to come into contact with each other. As will be understood from the above description, the pressure vessel 10 is made up of an inner liner and an outer fiber layer 27 disposed on the liner. However, the liner is omitted from each figure.

After the connection portions 30 are bent, a reinforcing member 70 may be further wound around the pressure vessel 10. The reinforcing member 70 is also made of CFRP. The reinforcing member 70 is wound around the outer periphery of all of the main body portions 20 of the pressure vessel 10 together. FIG. 3 shows a sectional view of the pressure vessel 10 after the reinforcing member 70 has been wound around the pressure vessel 10. FIG. 3 is a sectional view taken from the same point of view as FIG. 2. As shown in FIG. 3, the pressure vessel 10 includes the reinforcing member 70 that is wound around the outer periphery of the plurality of the main body portions 20 and fixes the main body portions 20 to one another. In FIG. 1, the area in which the reinforcing member 70 wound around the main body portions 20 from the outside is present is illustrated by a two-dot chain line. The reinforcing member 70 fixes the main body portions 20 to one another and improves the overall strength against fluid pressure.

The cross section of the connection portion 30 perpendicular to the flow path direction may have various shapes. The cross section of the connection portion 30 perpendicular to the flow path direction may have an oval shape like the main body portion 20, or may have a circular shape or a substantially quadrilateral shape. The term “oval” may broadly include an ellipse. Further, regardless of the cross-sectional shape, the connection portion 30 may have a so-called bellows structure in which mountain folds and valley folds are repeated. By providing the connection portion 30 in the bellows structure, the connection portion 30 is able to be easily bent.

In the pressure vessel 10, a base 40 is provided at one end of the main body portion 20 located at one end of the series connection among the main body portions 20. In FIG. 1, as indicated by two-dot chain lines, the bases 40 are respectively attached to one end of the main body portion 20 located at one end in the X direction and to one end of the main body portion 20 located at the other end. The base 40 is made of, for example, metal and is provided in an annular shape. For example, a member (not shown) that seals the opening 23 is fastened to the base 40. A member that communicates the opening 23 to a flow path (not shown) outside the pressure vessel 10 may be fastened to the base 40.

Although specific examples of the technique disclosed in the present specification have been described in detail above, the examples are merely examples and do not limit the scope of claims. The technique described in the claims includes various modifications and variations of the specific examples exemplified above. Further, the technical elements described in the present specification or in the drawings exhibit technical usefulness alone or in various combinations, and are not limited to the combinations described in the claims at the time of filing the application. In addition, the technique exemplified in the present specification or in the drawings achieves a plurality of purposes at the same time, and achieving one of the purposes itself has technical usefulness.

What is claimed is:

1. A pressure vessel that is able to store fluid, the pressure vessel comprising:
a plurality of main body portions provided with a space inside; and
one or more connection portions that communicate the main body portions to each other, wherein
the main body portion and the connection portion are alternately connected in series, and the connection portions are bent, and
a cross section perpendicular to a longitudinal direction of the main body portion has an outer shape including a linear portion and an arc portion.

2. The pressure vessel according to claim 1, wherein each of the main body portions is disposed such that an outer peripheral surface located on the linear portion is in contact with an outer peripheral surface located on the linear portion of an adjacent main body portion.

3. The pressure vessel according to claim 1, wherein:
the main body portions are arranged side by side along one direction;
the main body portion located in the middle in an arrangement has an oval shape in a cross section perpendicular to the longitudinal direction, the cross section including two linear portions and two arc portions; and
the main body portion located at both ends in the arrangement has a different outer shape from the oval shape in a cross section perpendicular to the longitudinal direction, the cross section including a single linear portion and a single arc portion.

4. The pressure vessel according to claim 1, further comprising a reinforcing member that is wound around an outer periphery of the plurality of main body portions and fixes the main body portions to one another.

5. The pressure vessel according to claim 1, wherein a cross section of the connection portion perpendicular to a flow path direction has either a circular shape, an oval shape, or a substantially quadrilateral shape.
